(19) United States
(12) Patent Application Publication
(10) Pub. No.: US 2017/0276632 A1
(43) Pub. Date: Sep. 28, 2017

(54) METHOD AND DEVICE FOR DETERMINING VOLUMETRIC SUFFICIENCY IN AN ELECTROCHEMICAL TEST STRIP

(71) Applicant: INSIDE BIOMETRICS LIMITED, Dingwall (GB)

(72) Inventors: Lawrence Ritchie, Dingwall (GB); Damian Baskeyfield, Dingwall (GB)

(21) Appl. No.: 15/500,159

(22) PCT Filed: Jul. 28, 2015
(86) PCT No.: PCT/EP2015/067296

§ 371 Date: Jan. 30, 2017

(30) Foreign Application Priority Data
Jul. 31, 2014 (GB) 1413628.7

(51) Int. Cl. G01N 27/327; G01F 22/00

(52) U.S. Cl. CPC G01N 27/3273; G01N 27/3272; G01F 22/00

(57) ABSTRACT

There is described a method of detecting or determining volumetric sufficiency in an electrochemical test strip having at least first and second conductive elements. The method comprises depositing or applying a fluid sample on the test strip, the test strip being arranged so as to allow the applied sample to flow from one of the conductive elements into contact with the other of the conductive elements and thereby form an electrical connection or other electrical continuity therebetween. The method further comprises applying a potential difference across the first and second conductive elements. A voltage across a capacitive element connected to one of the first and second conductive elements is then measured. The invention is able to provide a reliable means of establishing a point in time at which electrical continuity between two or more conductive elements (for example electrodes) of an electrochemical test strip is deemed to have occurred.

### TECHNOLOGICAL FIELD

The present disclosure relates to a method and device for determining volumetric sufficiency in electrochemical test strips and, in particular, relates to determining volumetric sufficiency in test strips as used with bodily fluid (e.g. blood) monitors for determining the concentration of analytes in an individual's bodily fluid sample.

### BACKGROUND

In the field of diagnostic devices such as used in the medical device industry, especially those used for analysing blood or other bodily fluid samples, it is often required for users to monitor biometrics such as the levels of certain chemicals, substances, or analytes present for example in their bloodstream. For instance, diabetics in particular must regularly monitor the concentrations of glucose in their blood in order to determine if they are in need of insulin. In order to respond effectively to an individual's needs to monitor blood sugar levels, diagnostic devices and kits have been developed over the years to allow an individual to autonomously determine the concentration of glucose in their bloodstream, in order to better anticipate the onset of hyperglycaemia or hypoglycaemia and take preventative action as necessary. The existence of such diagnostic devices places less strain on the healthcare system at large, as patients are able to administer insulin in their own home and without having to do so in the presence of a medical professional.

Typically, the patient will perform a fingerstick to extract a small drop of blood from a finger or alternative site, using a lancing device. An electrochemical test strip is then inserted into a diagnostic meter, and the sample is applied to the test strip. Through capillary action, the sample flows across a measurement chamber of the strip and into contact with one or more electrodes or similar conductive elements coated in sensing chemistry for interacting with a particular analyte or other specific chemical (for example glucose) in the blood sample. The magnitude of the reaction is dependent on the concentration of the analyte in the blood sample. The diagnostic meter may detect the current generated by the reaction of the reagent with the analyte, and the result can be displayed to the user.

This electrochemical test, which often must be repeated several times a day, has aspects that are dependent on the time since the sample was applied to the reagent. It is important that the time from reagent solvation to measurement point (generally carried out by the meter) is kept as consistent as possible, in order to ensure repeatable and reliable testing. In general, it is important to ensure that the reading taken by the meter is made when the sample chamber is determined to be sufficiently full. If the chamber is not sufficiently full, the blood may not be in proper contact with the electrodes, and there may be an insufficient reaction between the blood and the analyte for a measurement to take place. A measurement carried out before the sample chamber is determined to be sufficiently full would thus be taken too soon and may result in an erroneous and generally inaccurate reading.

US 2006/0231418 describes a method of detecting partial fill in an electrochemical test strip. It relies on observing a double-layer charging/discharging of a pair of opposing electrodes. However, one drawback of the method it discloses is that the method is restricted for use with opposing electrodes, and cannot be employed with test strips having co-planar electrodes.

WO 2011/104517 describes a method for determining fill sufficiency by determining the capacitance of a test chamber by applying an oscillating voltage to the electrodes. Again, such a method would not work well with test strips having co-planar electrodes, in which the electrodes may be at opposite ends of the chamber.

The method and devices described herein aim to provide a simple and cost-effective means of accurately determining volumetric sufficiency in an electrochemical test strip, that improve on the methods and devices currently available or described in the prior art.

### SUMMARY OF THE DISCLOSURE

In a first aspect, there is provided a method of detecting or determining volumetric sufficiency in an electrochemical test strip having at least first and second conductive elements. The method comprises depositing or applying a fluid sample on the test strip, the test trip being arranged so as to allow the applied sample to flow from one of the conductive elements into contact with the other of the conductive elements and thereby form an electrical connection or other electrical continuity therebetween. The method further comprises applying a potential difference across the first and second conductive elements. A voltage across a capacitive element connected to one of the first and second conductive elements is then measured.

Electrochemical test strips may be any relatively small strip of material on which an electrochemical reaction is designed to take place. Typically the strips are small enough to be inserted into and read by a handheld diagnostic meter.

The capacitive element, or capacitive component, may be a capacitor or any other electrical component arranged to store charge when a potential difference is applied across it. The capacitive element may be disposed on the electrochemical strip itself, and for example may be a removable capacitor-on-chip that is removable from the strip. In other embodiments, the capacitive element may be in a diagnostic device such as a meter arranged to receive the electrochemical test strip and read the voltage across the capacitive element. Furthermore, the capacitive element may be for example a removable capacitor-on-chip that is removable from the meter.

Volumetric sufficiency may be a state in which a predefined portion of a sample-receiving chamber of the electrochemical test strip is filled with the fluid sample. In some cases, volumetric sufficiency may be a ‘full’ or ‘filled’ state of the strip, i.e. when the sample chamber is completely or substantially completely filled with the fluid sample. In other cases, it may be sufficient for the chamber to be only partially full for volumetric sufficiency to be determined. This may be particularly useful for strips having multiple working electrodes. Strips with multiple working electrodes are relatively more expensive, and therefore by detecting volumetric sufficiency even if the sample chamber is not physically full of fluid may nonetheless allow the meter to take appropriate measurements for example from those working electrodes that have made contact with the sample.

The conductive elements may be electrodes, and may furthermore be coated in reagent so as to act as working electrodes in conjunction with their fill detect capacity. Throughout this disclosure, a “fill detect” element/electrode should be construed more generally as an element carrying out the function of providing an indication of when the sample comes into contact with it, whether this be partway across the measurement chamber or at an end of the measurement chamber. Thus, a “fill detect” electrode should not be held as meaning that the electrode in question is arranged in use to provide means for determining when the measurement chamber is completely full.

Thus, the described embodiments are able to provide a reliable means of establishing a point in time at which electrical continuity between two or more conductive elements (for example electrodes) of an electrochemical test strip is deemed to have occurred. The method uses the applied sample as an electrical pathway for current to charge a capacitive element such as a capacitor connected to one of the conductive elements. Once the voltage attains a pre-determined level or threshold within a predetermined period of time, the continuity may be deemed reliable, time-bound and complete. In particular, by observing the voltage and waiting for the voltage to cross a predetermined threshold within a predetermined period of time, the method is able to ensure that the liquid sample has flowed into contact with the conductive elements for a sufficient period of time to warrant the meter or other diagnostic device taking a reading from the working electrodes of the strip. If the reading is otherwise taken too soon, the sample may not have sufficiently covered the working electrode to generate a sufficiently strong current response.

A volumetric sufficiency of the electrochemical test strip may be determined according to when the measured voltage crosses the predetermined threshold.

Advantageously, the time constant of the capacitive element may be tailored as a function of the strip that is being analysed. The predetermined voltage threshold can therefore also be tailored as a function of the strip. Thus, it may be possible in some cases to tune the capacitive element (e.g. by using a variable resistor) to the strip being used, in particular to take into account different reaction rates due to the particular chemistry provided on the strip. Different rates of charging would allow for different solvation times for different reagent layer formulations on strips operating in the same meter.

Therefore, when the capacitive element is part of a diagnostic device, the device may be arranged to function only with a specific range of strips, e.g. strips having particular sensing chemistry provided thereon. When the strip is engaged with the meter, and once the capacitive element has charged, the meter may carry out an authentication check or ‘handshake’ by determining if the capacitive element charged at a rate expected of it given the particular strips that the meter is designed to read. In some cases, the diagnostic meter may indicate that the strip inserted into the meter is faulty or incorrect as the capacitive element charged at an insufficient rate.

With the method described herein, volumetric sufficiency may be determined without the use of complex current measurement or noise reduction apparatus, and thus provides for lower cost as compared to current incumbent systems.

When compared to prior art techniques where fill detection is generally determined on the basis of the area of the electrodes that are covered by the sample, with the presently described embodiments detection of volumetric sufficiency may be independent of the area of the electrode that is covered by the sample. Thus, a response is detectable prior to the working electrode being entirely covered in the sample, and thus any electrochemical reaction taking place before volumetric sufficiency is determined can be recorded and analysed. This may increase the options available to the meter for analyzing the current response from the working electrode and may improve result quality.

For example, monitoring the voltage across the capacitive element may allow one to monitor the sample conductivity at points on a potential divider circuit. Sample conductivity varies throughout the reaction as reagent concentrations change. As blood sample conductivity is a measure of blood parameters as well as chemistry parameters and is influenced by interferents, haematocrit, etc., these features may therefore be observed as voltage changes during the reaction.

Furthermore, the method may be carried out without resorting to circular buffering of electrode data, thus saving on processing power. Generally, if one wishes to observe data prior to triggering on a particular electrode, then the data is buffered and permanently stored once triggering has occurred. With the presently described embodiments, however, there is a reduced need to continuously rewrite to a memory location and instead the data may be permanently stored only once volumetric sufficiency has been determined. Increased processing power is therefore made available as a result.

Optionally, the electrochemical test strip further comprises an electrode, the test strip being further arranged so as to allow the applied sample to flow from one of the first and second conductive elements, to the electrode, and into contact with the other of the first and second conductive elements, and thereby form electrical continuity between the first and second conductive elements and the electrode.

Optionally, the method further comprises measuring a rate of charging of the capacitive element. This may allow tracking of the progression of the fluid sample across the conductive elements. The method may further comprise detecting a change in the rate of charging of the capacitive element.

Optionally, the method further comprises measuring the voltage across the capacitive element before the applied sample reaches the other of the conductive elements.

Optionally, the first and second conductive elements form a first electrode pair; the electrochemical test strip further comprises a second electrode pair, the test strip being further arranged so as to allow the applied sample to flow from the one of the electrode pairs into contact with the other of the electrode pairs and thereby form electrical continuity between the first and second electrode pairs; and the method further comprises: applying a potential difference across the second electrode pair; measuring a voltage across a further capacitive element connected to the second electrode pair.

Optionally, the method further comprises measuring the voltage across the further capacitive element before the applied sample reaches the other of the electrode pairs.

Optionally, the electrochemical test strip further comprises one or more additional electrodes. Optionally, the one or more additional electrodes are disposed between the first and second electrode pairs such that when flowing from one of the electrode pairs to the other of the electrode pairs the applied sample flows sequentially from one of the electrode pairs, to the one or more additional electrodes, and to the other of the electrode pairs.

Optionally, each conductive element is positioned at a respective end of a measurement chamber of the electrochemical test strip, the measurement chamber being arranged such that when flowing from one of the conductive elements to the other of the conductive elements the applied sample flows from one of the ends of the measurement chamber to the other of the ends of the measurement chamber.

The fluid sample may comprise a bodily fluid selected from the following: blood, plasma, urine, saliva, lacrimal fluid, sweat, and interstitial fluid; or breath condensate.

The electrochemical test strip may be a side-fill test strip or an end-fill test strip.

Optionally, a volumetric sufficiency of the electrochemical test strip is determined according to a rate of charging of the capacitive element.

Optionally, the method further comprises authenticating the electrochemical test strip as a function of a rate of charging of the capacitive element.

In a further aspect, there is provided a device for reading electrochemical test strips having at least first and second conductive elements. The device comprises means for receiving an electrochemical test strip. The device further includes a charging circuit including a capacitive element arranged to be in electrical connection with one of the first and second conductive elements when the electrochemical test strip is received in the device. The device further includes means for applying a potential difference across the first and second conductive elements when the electrochemical test strip is received in the device. The device further includes a processor configured to measure a voltage across the capacitive element.

Optionally, the processor is further configured to determine when the measured voltage crosses a predetermined threshold.

Optionally, the processor is further configured to measure a rate of charging of the capacitive element.

Optionally, the processor is further configured to determine when the measured rate of charging of the capacitive element changes.

Optionally, the first and second conductive elements form a first electrode pair; the electrochemical test strip further comprises a second electrode pair; the device further comprises a second charging circuit including a second capacitive element arranged to be in electrical connection with the second electrode pair when the electrochemical test strip is received in the device; and the processor is further configured to: apply a potential difference across the second electrode pair; measure a voltage across the second capacitive element.

Optionally, the device further comprises: switching means; and a discharging resistor for discharging the capacitive element when the switching means is operated to disconnect the capacitive element from the first and second conductive elements.

Optionally, the device further comprises a charging resistor for charging the capacitive element when the electrochemical test strip is received in the device and when a potential difference is applied across the first and second conductive elements.

In yet a further aspect, there is provided an electrochemical test strip comprising: a first conductive element and a second conductive element. The electrochemical test strip further comprises a measurement chamber arranged so as to allow an applied fluid sample to flow from one of the conductive elements into contact with the other of the conductive elements and thereby form electrical continuity therebetween. The electrochemical test strip further comprises a capacitive element connected to one of the first and second conductive elements.

In still a further aspect there is provided a machine-readable medium having instructions stored thereon. The instructions are configured such that when read by a machine the instructions cause the method as defined in any of the appended claims to be carried out.

### BRIEF DESCRIPTION OF THE DRAWINGS

Specific embodiments will now be described in conjunction with the accompanying drawings, of which:

FIG. 1 is an exploded view of an electrochemical test strip that may be used with the presently described embodiments;

FIGS. 2A and 2B are schematic diagrams of a circuit including a test strip and meter setup in accordance with a first embodiment;

FIG. 3 is a schematic diagram of a second circuit including a test strip and meter setup in accordance with a second embodiment;

FIGS. 4A and 4B are schematic diagrams of a third circuit including a test strip and meter setup in accordance with a third embodiment;

FIG. 5 is a flowchart of the steps taken by a method in accordance with an embodiment;

FIGS. 6A and 6B are graphs showing typical capacitor charge plots in accordance with the embodiments of FIGS. 2A-4B; and

FIG. 7 is a graph showing experimental capacitor charge plots obtained according to an embodiment.

### DETAILED DESCRIPTION OF SPECIFIC EMBODIMENTS

The presently described embodiments seek to provide improved methods and devices for determining volumetric sufficiency in an electrochemical test strip. Whilst various embodiments are described below, the description is not intended to be limited to these embodiments, and variations of these embodiments may well fall within the contemplated scope, which is to be limited only by the appended claims.

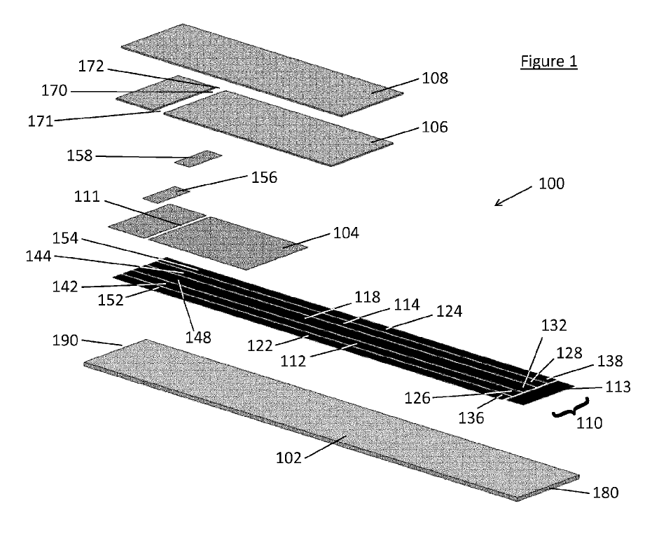

An electrochemical test strip, test strip or simply strip, as may be used with the described embodiments is shown in exploded form in FIG. 1. Test strip 100 is an 8 mm-wide strip and includes a number of so-called coplanar electrodes in that the electrodes are adjacent one another and share a common plane. This is in contrast to test strips having co-facial electrodes, whereby the electrodes are parallel yet in different planes, and effectively face each other. Whilst embodiments are described in terms of their use with a test strip having co-planar electrodes, various embodiments may also include co-facing, or opposing, electrodes. Of course, strip 100 may take various other dimensions as required. A greater or lesser number of electrodes may be included on strip 100 depending on the number of measurements that strip 100 is configured to make.

Test strip 100 is a multi-layered strip having a proximal end 180 and a distal end 190. Strip 100 comprises from bottom to top: first substrate layer 102, electrically conductive layer 110, dielectric insulation layer 104, reagent layers 156 and 158, patterned spacer layer 106, and second substrate layer 108.

First substrate layer 102 is typically formed of an inert polymeric material such as PET, polyethylene, polypropylene, PBT, ABS or polybutylene. Electrically conductive layer 110 is formed on top of first substrate layer 102 using screen-printing, thin-film evaporation followed by laser ablation, sputtering over a pre-formed mask, or electrolysis deposition. Other means of forming conductive layer 110 may be used, such as photolithography, although thick-film screen printing is preferred.

Conductive layer 110 comprises a plurality of electric tracks that connect the electrodes at distal end 190 of strip 100 to corresponding conductive pads at proximal end 180 of strip 100. The tracks run parallel to each other and substantially along the length of first substrate layer 102. In sequential order, conductive layer 110 comprises: first fill detect track 122, first working track 112, reference track 118, second working track 114 and second fill detect track 124. Suitable materials for electrically conductive layer 110 include gold, carbon, platinum, palladium, gold/palladium composites, indium tin oxide film, platinised carbon and other typically low-resistance non-corroding materials as known to those skilled in the art.

At proximal end 180 of strip 100 each track defines a plurality of respective contact pads. In sequential order, conductive layer 110 comprises at distal end 180: first fill detect contact pad 136, first working contact pad 126, reference contact pad 132, second working contact pad 128 and second fill detect contact pad 138. Pads are arranged to make electrical connection with corresponding circuit components of a strip meter or reader when strip 100 is inserted into the meter. A meter switch-on bar 113 is included adjacent the contact pads, although in other embodiments activation of the meter may be carried out using other means, for example across an end of one of the tracks.

At distal end 190 of strip 100, the tracks define co-planar electrodes arranged side-by-side and in parallel to one another. In sequential order, the electrodes comprise: first fill detect electrode 152, first working electrode 142, reference/counter electrode 148, second working electrode 144 and second fill detect electrode 154.

The electrodes are covered by insulation layer 104 having an open area or spacing 111 allowing a portion of each of the electrodes to remain uncovered. First and second reagent layers 156 and 158 (containing for example an enzyme, mediator, buffer salts, polymers, viscosity modifiers, etc.) are then deposited on insulation layer 104, and in particular over spacing 111, so as to bring reagent layers 156 and 158 into contact with fill detect electrodes 152 and 154 as well as first and second working electrodes 136 and 138. Each reagent layer 156, 158 is furthermore disposed over at least a portion of reference/counter electrode 148. Alternatively, at least one of reagent layers 156 and 158 substantially covers reference/counter electrode 148. In other embodiments, first and second reagent layers 156 and 158 may only coat first and second working electrodes 136 and 138.

A chamber-defining spacer layer 106 is then laid on top of insulation layer 104 so as to cover insulation layer 104. Spacer layer 106 defines sample-receiving chamber 170 which is positioned over first and second reagent layer 156 and 158. Chamber 170 is bounded at both ends by apertures 171 and 172. Spacer layer 106 includes an adhesive layer on its underside so as to allow spacer layer 106 to adhere to the tracks and electrodes of conductive layer 110 as well as to insulation layer 104.

Second substrate layer 108 which is a transparent layer is then positioned over spacer layer 106, and adheres to spacer layer 106 using an adhesive layer on its underside. Second substrate layer 106 can be laid down individually or more preferably as a single pre-laminated layer, laminated to spacer layer 106.

Once test strip 100 is manufactured, a fluid sample such as a blood sample may be applied to test strip 100. Test strip 100 is a side-fill strip in that the fluid sample may be introduced from either side of strip 100 via either aperture 171 or aperture 172. However, it should be noted that the contemplated embodiments may be used with end-fill strips, that is strips having a chamber arranged such that the sample may only be introduced into the chamber via a single entry point.

To apply the blood sample, a small volume (of the order of less than 1 mL and preferably of approximately 5004 or less) is applied at an end of sample-receiving chamber 170, either via aperture 171 or aperture 172. Through capillary action, the sample will flow from one end of chamber 170 to the other end. The aperture through which the sample was not applied acts as an air vent as the blood flows from one aperture to the other.

The sample gradually flows into contact with reagent layers 156 and 158 coating first and second working electrodes 142 and 148, reference/counter electrode 148, and first and second fill detect electrodes 152 and 154. For example, if the sample is introduced into chamber 170 via aperture 172 then the sample flows first into contact with reagent layer 158 coating second fill detect electrode 154, second working electrode 144 and reference/counter electrode 148. The sample will then flow into contact with reference/counter electrode 148. Finally the sample flows into contact with reagent layer 156 coating reference/counter electrode 148, first working electrode 142 and first fill detect electrode 152.

As known in the art, specific analytes and other chemicals in the blood will react with reagent layers 156 and 158, depending on the reagent that is used. The reaction leads to an electrical current generated at the electrode and dependent on the concentration of the analyte in the blood. When strip 100 is inserted into a strip meter or other diagnostic meter, the current may be detected and converted into a signal for processing and display to a user. For example, if the meter is a glucose meter arranged to determine concentrations of glucose, the level of glucose in the blood applied to strip 100 may be inferred from the reaction that takes place.

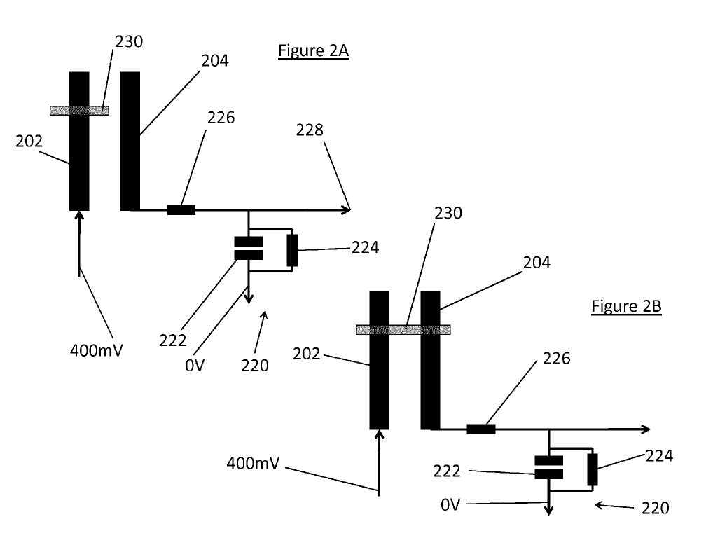

A method of determining volumetric sufficiency in an electrochemical test strip will now be described, in accordance with specific embodiments. In a first embodiment, the method is described in connection with a two-electrode test strip, comprising a working electrode 202 and a fill detect electrode 204 (which acts as a reference/counter electrode), as can be seen in FIGS. 2A and 2B. The test strip is similar to test strip 100, except for the fact that only two electrodes are present. For clarity, only electrodes 202 and 204 of the test strip are shown in FIGS. 2A and 2B, and other portions of the test strip have been omitted. The electrode arrangement is exemplary of an electrode pair that could form part of an end-fill test strip, in which blood is applied at an opening adjacent working electrode 202 and flows to fill detect electrode 204 at an end of the sample-receiving chamber. Working electrode 202 and fill detect electrode 204 are at least partially coated with a reagent arranged to react with an analyte in a blood sample when the blood is in contact with the reagent, although in some cases it may be possible to have only working electrode 202 coated in the reagent, for example if a Ag/AgCl coating is used and as known in the art.

A charging circuit 220 is connected to fill detect electrode 204. Charging circuit 220 forms part of the meter into which the test strip is inserted. Charging circuit 220 comprises a capacitor 222, a discharging resistor 224 and a charging resistor 226. The meter further comprises an analogue to digital converter 228 (not shown).

A blood bridge 230 can be seen extending across working electrode 202 in FIG. 2A. Thus, FIG. 2A is representative of the blood sample having not yet flowed across the entirety of the sample-receiving chamber of the test strip, as the blood is only in contact with working electrode 202. FIG. 2A therefore represents volumetric insufficiency or an unfilled state of the strip. In FIG. 2B, blood bridge 230 extends from working electrode 202 into contact with fill detect electrode 204. FIG. 2B thus represents volumetric sufficiency, or a filled state of the strip. The boundaries of blood bridge 230 schematically illustrate the boundaries of the sample-receiving chamber of the test strip.

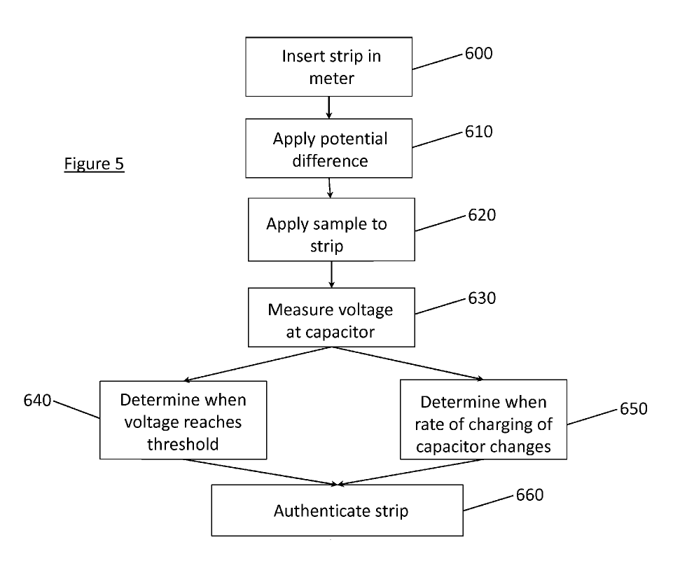

Now turning to FIG. 5, there is shown a flowchart illustrating the various steps that are taken to determine volumetric sufficiency in the test strip, according to a method. It should be noted that FIG. 5 shows an example method, and the order of the steps may be changed (for example the point in time at which the strip is inserted in the meter) without departing from the contemplated scope. The method may also comprise a fewer or greater number of steps.

At step 600, the test strip is inserted into the meter and engages charging circuit 220 in a reading position. In the reading position, working electrode 202 is connected to a voltage source whilst fill detect electrode 204 is connected to charging circuit 220 before charging resistor 226.

At step 610, a potential difference (e.g. 400 mV) is applied across working electrode 202 and fill detect electrode 204. At step 620, a blood sample is applied to the strip as described above. In the case of an end-fill strip, the sample is applied at an end of the measurement chamber adjacent working electrode 202. The blood then flows from working electrode 202 to fill detect electrode 204 (as shown in FIGS. 2A and 2B). In some embodiments, it may be possible to apply the blood sample to the strip before the strip is received in the meter, depending on the strip and/or meter architecture.

Whilst blood bridge 230 remains unfilled (FIG. 2A), no current flows from one electrode to the other. When the applied blood has flowed to a point such that blood bridge extends across working electrode 202 and fill detect electrode 204 (FIG. 2B), continuity is made between working electrode 202 and fill detect electrode 204 and current flows between working electrode 202 and fill detect electrode 204. As it does so charge builds up on a capacitor plate of capacitor 222, and the voltage across capacitor 222 increases accordingly. Charging resistor 226 allows charge to build up on capacitor 222 in a controlled fashion. As known in the art, the voltage will increase at a rate proportional to a time constant T=RC where R is the resistance of charging resistor 226 and C is the capacitance of capacitor 222.

At step 630, the positive voltage is detected at ADC 228 by a microprocessor within the meter. At step 640, when the voltage reaches a pre-determined limit, for example 100 mV, the microprocessor determines that a connection has been made between working electrode 202 and fill detect electrode 204. At step 660, the meter carries out a ‘handshake’ or authorisation check whereby the meter may determine if capacitor 222 charged at a sufficient rate to warrant a current reading from working electrode 202, e.g. to warrant determination of volumetric sufficiency. If the handshake is successful, then the meter determines that the measurement chamber is full or otherwise has achieved volumetric sufficiency.

The meter may then discharge capacitor 222 by activating switching means (not shown) arranged to disconnect capacitor 222 from electrodes 202 and 204. Discharging resistor 224 allows capacitor 222 to controllably discharge. Once disconnected, the microprocessor may measure the current generated as a function of the blood interacting with the reagent on working electrode 202. The current measurement allows the meter to determine for example the level of glucose in the blood sample, and display the result to the user.

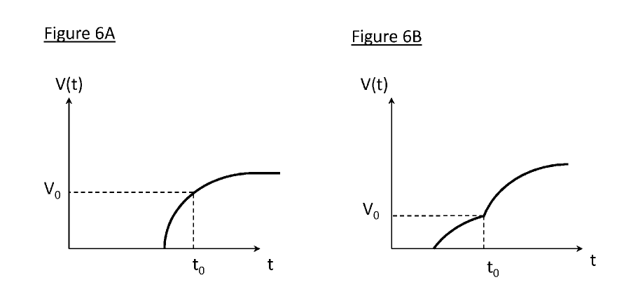

An example V(t) curve generated across capacitor 222 in the circuit of FIGS. 2A and 2B can be seen in FIG. 6A. At t=t₀ volumetric sufficiency is determined (e.g. once the voltage reaches a predetermined threshold).

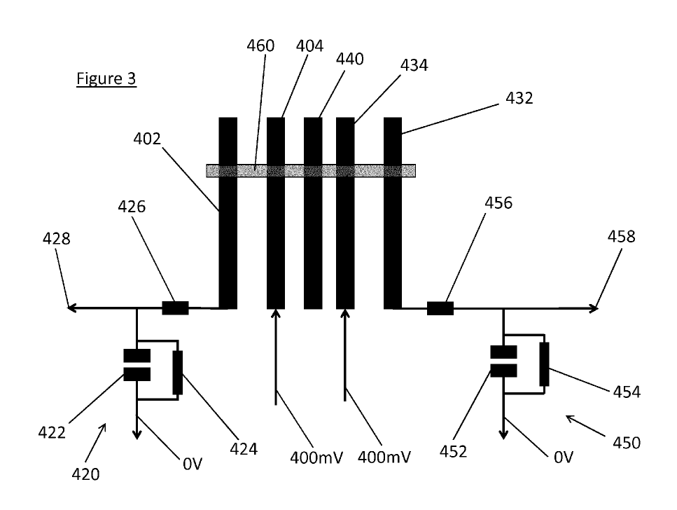

FIG. 3 shows a similar setup this time using a strip with multiple working electrodes, as in the case of test strip 100 described in connection with FIG. 1. In FIG. 3, there are two charging circuits 420 and 450, each with a respective capacitor 422, 452, respective discharging resistors 424, 454. Charging circuits 420 and 450 further comprise charging resistors 426 and 456 arranged to allow capacitors 422 and 452 to controllably charge when current flows between working electrodes 404 and 434 and fill detect electrodes 402 and 432. Each charging circuit 420 and 450 is connected to a respective pair of electrodes. Each pair comprises a fill detect electrode 402, 432 adjacent a respective working electrode 404, 434. Each fill detect electrode 402 and 432 effectively bounds the sample-receiving chamber of the test strip at opposite ends. A fifth electrode 440 is illustrated to show that other electrodes may be in operation as well as fill detect and working electrodes 402, 404, 432 and 434 (for example in the case where the strip is designed to carry out more than two measurements).

The meter further includes analogue-to-digital converters 428 and 458 (not shown) arranged to measure current generated by the reaction of blood with reagents on working electrodes 404 and 434. A blood bridge 460 is shown extending across each of the fill detect and working electrodes 402, 404, 432, 434, thus representing a test strip that is deemed full or volumetrically sufficient.

The steps taken to detect volumetric sufficiency are similar to those described in connection with the embodiment of FIGS. 2A and 2B. Again turning to FIG. 5, at step 600 the strip is inserted into the meter such that it engages with charging circuits 420 and 450. At step 610 potential differences (of e.g. 400 mV) are applied across electrodes 402 and 404, and 434 and 432. At step 620 a blood sample is applied to the test strip, at an aperture of the sample chamber that is either adjacent fill detect electrode 402 or fill detect electrode 432. The blood then flows from one end of the chamber to the other. Assuming the blood was applied adjacent fill detect electrode 402, then when the blood has flowed from fill detect electrode 402 to working electrode 404 current will flow through charging circuit 420 and charge will begin to build up on a capacitor plate of capacitor 422.

At step 630, the microprocessor in the meter is arranged to detect the voltage across capacitor 422, and at step 640 the meter determines when the voltage reaches a predetermined point. At step 660 the meter carries out a check to determine whether capacitor 422 charged at a rate sufficient to warrant a determination of volumetric sufficiency (e.g. the meter authenticates the strip). If the check is successful, then the meter determines that the blood bridge extends from fill detect electrode 402 to working electrode 404. Thus, fill initiation is detected once blood has crossed the first bounding set of electrodes (e.g. electrodes 402 and 404) to allow capacitor 422 to charge.

Similarly, when the blood has flowed into contact with working electrode 434 and fill detect electrode 432, current will flow through charging circuit 450 and charge will accumulate in capacitor 452. The increase in voltage may be detected by the microprocessor in the reader (step 630) and the meter may further more detect when the voltage crosses the predetermined threshold (step 640). Volumetric sufficiency is detected once the second set of bounding electrodes (e.g. electrodes 434 and 432) registers appropriate capacitor charge, following an authentication check that verifies whether capacitor 452 charged at a sufficient rate (step 660).

Should only one charging circuit indicate continuity then the chamber is deemed not to be filled. Nonetheless, even if only capacitor 422 registers a build-up of charge then volumetric sufficiency may still be detected in that the blood is deemed to have flowed into contact with working electrode 404. Therefore, an analyte detection on the basis of current generated at electrode 404 may be carried out by the reader.

An example V(t) curve generated across capacitors 422 and 452 in the circuit of FIG. 3 can be seen in FIG. 6A. At t=t₀ volumetric sufficiency is determined (e.g. once the voltage reaches a predetermined threshold).

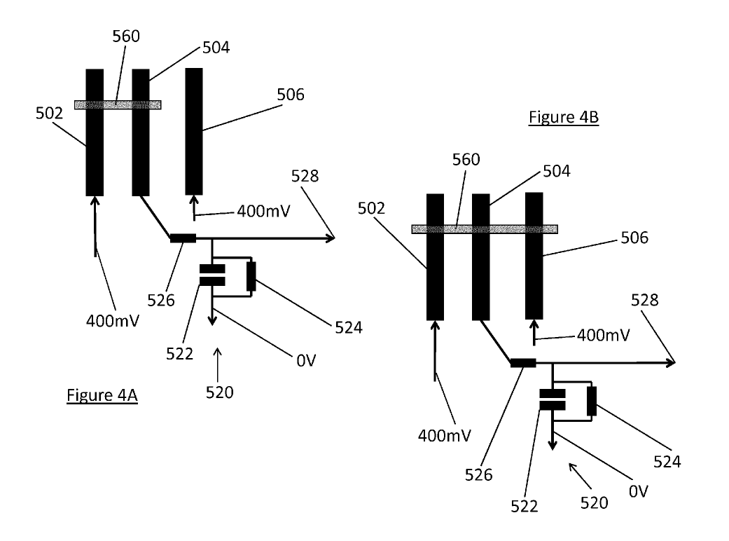

According to a third embodiment, there is shown in FIGS. 4A and 4B two states of an electrochemical test strip engaged with a charging circuit of a meter. The strip includes three electrodes: working electrodes 502 and 506, and fill detect electrode 504. Charging circuit 520 (in the meter) includes as before capacitor 522 arranged in parallel with discharging resistor 524, as well as charging resistor 526. The meter further includes analogue-to-digital converter 528 (not shown). In FIG. 4A, blood bridge 560 extends from working electrode 502 to fill detect electrode 504. In FIG. 4B, blood bridge 560 extends from working electrode 502 to working electrode 506, over fill detect electrode 504.

The process of detecting volumetric sufficiency in the test strip of FIGS. 4A and 4B is the same as that described in connection with FIGS. 2A-3. At step 600, the strip is inserted into the meter. At step 610, a potential difference (of e.g. 400 mV) is applied across working electrode 502 and fill detect electrode 504, as well as across fill detect electrode 504 and working electrode 506. At step 620, a blood sample is applied to the strip adjacent working electrode 502. Of course in other embodiments the sample may be instead applied adjacent working electrode 506. The blood then flows from working electrode 502 to working electrode 506.

Once blood bridge 560 extends from working electrode 502 to fill detect electrode 504 (FIG. 4A) so as to form electrical continuity therebetween, capacitor 522 in charging circuit 520 charges at a first rate. Blood will continue to flow from fill detect electrode 504 to working electrode 506, at which point capacitor 522 will charge at an increased second rate. The rates will be dependent on the potential differences applied to working electrodes 502 and 506. At step 630, the voltage across capacitor 522 is measured. At step 650, the meter determines when the rate of charging increases and therefore determined the point in time when the blood sample has flowed into contact with working electrode 506. At step 660, the meter carries out a check to determine whether capacitor 522 charged at a rate sufficient to warrant a determination of volumetric sufficiency. If the check is successful, the meter determines that volumetric.

An example V(t) curve generated across capacitor 522 in the circuit of FIGS. 4A and 4B can be seen in FIG. 6B. At t=t₀ volumetric sufficiency is determined (e.g. once the rate of charging increases).

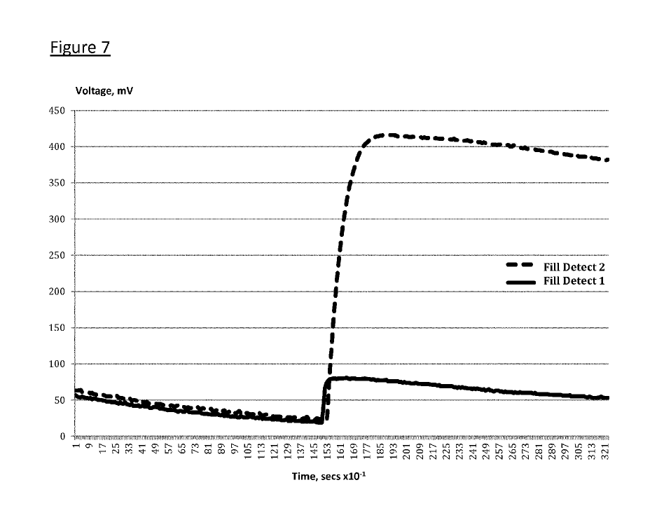

FIG. 7 shows experimental readouts of voltage against time for a volumetric sufficiency detection method in accordance with an embodiment. Detection was effected via a capacitor of 22 μF and a charging resistor of 33 kΩ, giving a time constant RC of 0.73 seconds. Of course as mentioned before the time constant may be tailored (by changing C and/or R accordingly) for example to detect volumetric sufficiency more quickly, and to take into account different solvation rates for different analytes/reagents. A rapid detection time of 1 ms may be effected through the use of a 1 kΩ resistor and a 1 μF capacitor. A long detection time that allowed a significant amount of chemistry to occur on the working electrode could use a 22 μF capacitor and 100 kΩ resisitor, giving a time constant of 2.2 s.

Given the different maximum voltages that are obtained for Fill Detect 1 and Fill Detect 2, the plot could represent the situation where different fill detect electrodes having different areas were used. Alternatively, the plots could represent the situation where two different capacitors were used, each having different a capacitance.

Any feature of the above-described embodiments may be combined with the features of another embodiment, by making the appropriate changes. For example, the fact that the embodiment of FIGS. 4A and 4B shows a pair of working electrodes bounding a fill detect electrode may be applied to the embodiments of FIGS. 2A and 2B, and that of FIG. 3.

Whilst described in connection with preferred embodiments, it is to be understood that the scope of the claims is not limited to these embodiments, and that alterations, modifications, and variations of these embodiments may be carried out by the skilled person without departing from that scope. For instance, whilst the described primarily in the context of determining volumetric sufficiency with diagnostic devices, the described methods and devices may equally well be used in other fields, for example in health and fitness, food, drink, bio-security applications, environmental sample monitoring, etc.

1. A method of determining volumetric sufficiency in an electrochemical test strip having at least first and second conductive elements, comprising:
applying a fluid sample to the test strip, the test strip being arranged so as to allow the applied sample to flow from one of the conductive elements into contact with the other of the conductive elements and thereby form electrical continuity therebetween;
applying a potential difference across the first and second conductive elements; and
measuring a voltage across a capacitive element connected to one of the first and second conductive elements.

2. The method of claim 1, wherein the first and second conductive elements are electrodes.

3. The method of claim 1, further comprising detecting when the measured voltage crosses a predetermined threshold.

4. The method of claim 3, wherein a volumetric sufficiency of the electrochemical test strip is determined according to when the measured voltage crosses the predetermined threshold.

5. The method of claim 1, wherein the electrochemical test strip further comprises an electrode, the test trip being further arranged so as to allow the applied sample to flow from one of the first and second conductive elements, to the electrode, and into contact with the other of the first and second conductive elements, and thereby form electrical continuity between the first and second conductive elements and the electrode.

6. The method of claim 1, further comprising measuring a rate of charging of the capacitive element.

7. The method of claim 6, further comprising detecting a change in the rate of charging of the capacitive element.

8. The method of claim 1, further comprising measuring the voltage across the capacitive element before the applied sample reaches the other of the conductive elements.

9. The method of claim 1, wherein:
the first and second conductive elements form a first electrode pair;
the electrochemical test strip further comprises a second electrode pair, the test trip being further arranged so as to allow the applied sample to flow from the one of the electrode pairs into contact with the other of the electrode pairs and thereby form electrical continuity between the first and second electrode pairs; and
the method further comprises:
applying a potential difference across the second electrode pair;
measuring a voltage across a further capacitive element connected to the second electrode pair.

10. The method of claim 9, further comprising measuring the voltage across the further capacitive element before the applied sample reaches the other of the electrode pairs.

11. The method of claim 9, wherein the electrochemical test strip further comprises one or more additional electrodes.

12. The method of claim 11, wherein the one or more additional electrodes are disposed between the first and second electrode pairs such that when flowing from one of the electrode pairs to the other of the electrode pairs the applied sample flows sequentially from one of the electrode pairs, to the one or more additional electrodes, and to the other of the electrode pairs.

13. The method of claim 9, wherein each conductive element is positioned at a respective end of a measurement chamber of the electrochemical test strip, the measurement chamber being arranged such that when flowing from one of the conductive elements to the other of the conductive elements the applied sample flows from one of the ends of the measurement chamber to the other of the ends of the measurement chamber.

14. The method of claim 1, wherein the fluid sample comprises:
a bodily fluid selected from the following: blood, plasma, urine, saliva, lacrimal fluid, sweat, and interstitial fluid; or
breath condensate.

15. The method of claim 1, wherein the electrochemical test strip is a side-fill test strip.

16. The method of claim 1, wherein the electrochemical test strip is an end-fill test strip.

17. The method of claim 1, wherein a volumetric sufficiency of the electrochemical test strip is determined according to a rate of charging of the capacitive element.

18. The method of claim 1, further comprising authenticating the electrochemical test strip as a function of a rate of charging of the capacitive element.

19. A device for reading electrochemical test strips having at least first and second conductive elements, comprising:
means for receiving an electrochemical test strip;
a charging circuit including a capacitive element, the charging circuit being arranged to be in electrical connection with one of the first and second conductive elements when the electrochemical test strip is received in the device;
means for applying a potential difference across the first and second conductive elements when the electrochemical test strip is received in the device; and
a processor configured to measure a voltage across the capacitive element.

20-26. (canceled)

27. A machine-readable medium having instructions stored thereon, the instructions being configured such that when executed by a microprocessor the instructions cause the microprocessor to perform a method for determining the volumetric sufficiency in an electrochemical test strip having at least first and second conductive elements, the method comprising:
applying a fluid sample to the test strip, the test strip being arranged so as to allow the applied sample to flow from one of the conductive elements into contact with the other of the conductive elements and thereby form electrical continuity therebetween;
applying a potential difference across the first and second conductive elements; and
measuring a voltage across a capacitive element connected to one of the first and second conductive elements.

28-30. (canceled)
